(19) United States
(12) Patent Application Publication
(10) Pub. No.: US 2007/0075060 A1
(43) Pub. Date: Apr. 5, 2007

(54) Method of manufacturing a medical device from a workpiece using a pulsed beam of radiation or particles having an adjustable pulse frequency

(76) Inventors: Matthew S. Shedlov, Rockford, MN (US); Ken Merdan, Greenfield, MN (US)

Correspondence Address: MAYER & WILLIAMS PC, 251 NORTH AVENUE WEST, 2ND FLOOR, WESTFIELD, NJ, 07090, US

(21) Appl. No.: 11/240,148

(22) Filed: Sep. 30, 2005

(51) Int. Cl. B23K 26/38

(52) U.S. Cl. 219/121.72

(57) ABSTRACT

A method of manufacturing a medical device from a workpiece is provided. The method begins by generating a pulsed beam of radiation from a radiation source. The pulsed radiation beam is characterized by a prescribed pulse frequency. The pulsed radiation beam is directed onto the workpiece and the workpiece is moved relative to the radiation source so that a prescribed pattern is cut in the workpiece by the pulsed radiation beam. The prescribed pulse frequency is adjusted based on a change in a parameter pertaining to the relative motion of the workpiece.

### FIELD OF THE INVENTION

The present invention relates generally to cutting, welding and coating techniques, and more specifically to techniques that employ a pulsed beam of radiation or particles having an adjustable pulse frequency to cut, weld or coat medical devices such as stents.

### BACKGROUND OF THE INVENTION

Stent and stent delivery devices are employed in a number of medical procedures and as such their structure and function are well known. Stents are used in a wide array of bodily vessels including coronary arteries, renal arteries, peripheral arteries including iliac arteries, arteries of the neck and cerebral arteries as well as in other body structures, including but not limited to arteries, veins, biliary ducts, urethras, fallopian tubes, bronchial tubes, the trachea, the esophagus and the prostate.

Stents are typically cylindrical, radially expandable prostheses introduced via a catheter assembly into a lumen of a body vessel in a configuration having a generally reduced diameter, i.e. in a crimped or unexpanded state, and are then expanded to the diameter of the vessel. In their expanded state, stents support or reinforce sections of vessel walls, for example a blood vessel, which have collapsed, are partially occluded, blocked, weakened, or dilated, and maintain them in an open unobstructed state. To be effective, the stent should be relatively flexible along its length so as to facilitate delivery through torturous body lumens, and yet stiff and stable enough when radially expanded to maintain the blood vessel or artery open. Such stents may include a plurality of axial bends or crowns adjoined together by a plurality of struts so as to form a plurality of U-shaped members coupled together to form a serpentine pattern.

Stents may be formed using any of a number of different methods. One such method involves forming segments from rings, welding or otherwise forming the stent to a desired configuration, and compressing the stent to an unexpanded diameter. Another such method involves machining tubular or solid stock material into bands and then deforming the bands to a desired configuration. While such structures can be made many ways, one low cost method is to cut a thin-walled tubular member of a biocompatible material (e.g. stainless steel, titanium, tantalum, super-elastic nickel-titanium alloys, high-strength thermoplastic polymers, etc.) to remove portions of the tubing in a desired pattern, the remaining portions of the metallic tubing forming the stent. Since the diameter of the stent is very small, the tubing from which it is made must likewise have a small diameter. For example, stents may have an outer diameter of about 0.045 inch in their unexpanded configuration and can be expanded to an outer diameter of about 0.1 inch or more. The wall thickness of the stent may be approximately 0.003 inch. In part because of their small dimensions, manufacturing techniques that are employed in the aforementioned processes often involve laser welding and laser cutting.

Laser cutting of stents has been described in a number of publications including U.S. Pat. No. 5,780,807 to Saunders, U.S. Pat. No. 5,922,005 to Richter and U.S. Pat. No. 5,906,759 to Richter.

Laser cutting usually involves the use of a pulsed laser beam and a stent preform such as a tubular preform that is positioned under the laser beam and moved in a precise manner to cut a desired pattern into the preform using a servo motion controlled machine tool. One problem that arises when a stent or other medical device is manufactured in this manner is that the pulsed laser beam does not cut the preform in a uniform manner because the preform is not moved throughout the process with a constant velocity. That is, the preform undergoes a change in speed and/or direction in order to form the desired pattern. As a result, the number of pulses or power density that impinges on any given portion of the preform will be different from location to location because of the changes in velocity. This nonuniformity in the fabrication process can result in a stent with nonuniform mechanical, geometric, surface, and chemical properties that are generally less than optimal throughout its structure.

### SUMMARY OF THE INVENTION

In accordance with the present invention, a method of manufacturing a medical device from a workpiece is provided. The method begins by generating a pulsed beam of radiation from a radiation source. The pulsed radiation beam is characterized by a prescribed pulse frequency. The pulsed radiation beam is directed onto the workpiece and the workpiece is moved relative to the radiation source so that a prescribed pattern is cut in the workpiece by the pulsed radiation beam. The prescribed pulse frequency is adjusted based on a change in a parameter pertaining to the relative motion of the workpiece.

In accordance with one aspect of the invention, the prescribed pulse frequency is adjusted so that individual pulses are spaced apart from one another when impinging on the workpiece by a fixed distance.

In accordance with another aspect of the invention, the parameter pertaining to the relative motion of the workpiece is relative velocity.

In accordance with another aspect of the invention, the parameter pertaining to the relative motion of the workpiece is a relative position of a feature associated with workpiece.

In accordance with another aspect of the invention, the prescribed pulse frequency decreases as the relative velocity decreases and increases as the prescribed velocity decreases.

In accordance with another aspect of the invention, the workpiece is a tubular workpiece.

In accordance with another aspect of the invention, the workpiece is planar at least in part.

In accordance with another aspect of the invention, the workpiece comprises a material selected from the group consisting of stainless steel, Nitinol, cobalt, chromium, titanium, tantalum, platinum, magnesium, niobium, iron, and alloys thereof.

In accordance with another aspect of the invention, the material is a biocompatible material.

In accordance with another aspect of the invention, the material is a composite material.

In accordance with another aspect of the invention, the medical device is a stent.

In accordance with another aspect of the invention, the medical device is a catheter.

In accordance with another aspect of the invention, the medical device is a bio-absorbable device.

In accordance with another aspect of the invention the medical device is a guidewire.

In accordance with another aspect of the invention, the radiation beam is a laser beam.

In accordance with another aspect of the invention, the radiation source generating the pulsed beam is a laser source.

In accordance with another aspect of the invention, the laser source is a fiber laser source.

In accordance with another aspect of the invention, a method of processing a medical device formed from a workpiece is provided. The method begins by applying a pulsed processing agent onto the workpiece from a source. The workpiece is moved relative to the source so that the processing agent is applied to the workpiece in a prescribed pattern. A characteristic of the pulsed processing agent is adjusted based on a change in a parameter pertaining to the relative motion of the workpiece.

### BRIEF DESCRIPTION OF THE DRAWINGS

FIGS. 1 and 2 show in fragment portions of an exemplary stent that may be manufactured in accordance with the present invention.

FIG. 3 is a schematic representation of one example of a machine-controlled laser cutting system that may be employed in the present invention.

FIG. 4 is a plan view of an undulating segment of a stent formed by the application of fixed frequency laser pulses.

FIG. 5 shows a plan view of the undulating stent segment depicted in FIG. 4 except that in FIG. 5 the laser beam operates to produce a train of pulses with an adjustable pulse frequency to ensure that the pulses are evenly spaced when they are applied along the stent segment.

### DETAILED DESCRIPTION

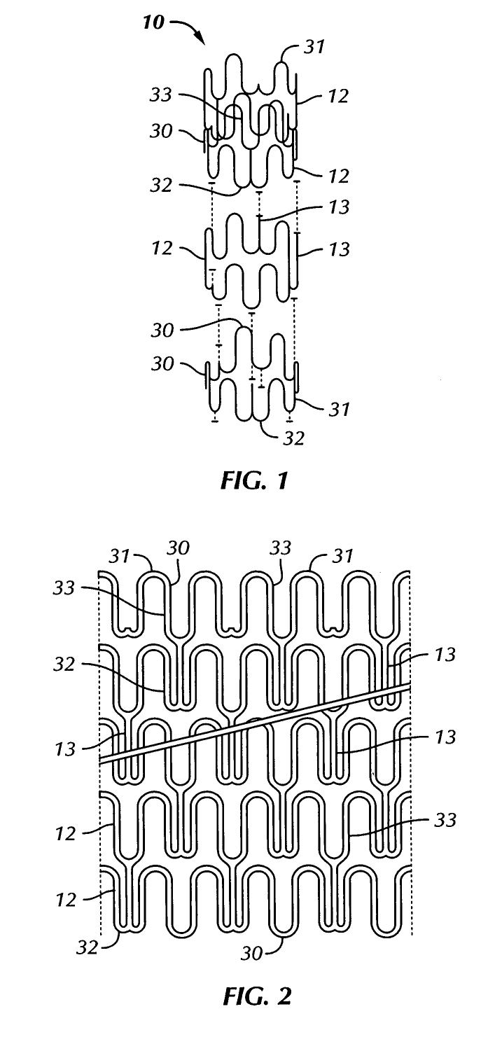

The present invention applies laser processing techniques to fabricate a wide variety of medical devices including, without limitation, stents, guidewires, filter devices, stone retrieval devices and the like. As discussed in detail below, the laser pulses are applied to a preform so that they impinge on the preform with a fixed incremental distance between them, even as the velocity of the preform changes. In this way more optimal cutting results can be achieved to better maintain mechanical uniformity throughout the resulting structure and to provide more uniformity to the surface that is cut or otherwise processed. For purposes of illustration only and not as a limitation on the invention, the present invention will be described in terms of stents formed from a cylindrical metal mesh that can expand when pressure is internally applied. One example of such a stent, described below, is shown in FIGS. 1-2. Of course, the present invention is equally applicable to a wide variety of other types of stents including, without limitation, various balloon-expandable and self-expanding stents, as well as those formed from a sheet or tube into spiral, coil or woven geometries, either open or closed cell.

Having reference to FIG. 1, there is shown an exemplary stent 10. The stent generally comprises a plurality of radially expandable cylindrical elements 12 disposed generally coaxially and interconnected by elements 13 disposed between adjacent cylindrical elements 12. The cylindrical elements 12 have an undulating pattern. The particular pattern and number of undulations per unit of length around the circumference of the cylindrical element 12, or the amplitude of the undulations, are chosen to fill particular mechanical requirements for the stent 10 such as radial stiffness.

Each pair of the interconnecting elements 13 on one side of a cylindrical element 12 can be placed to achieve maximum flexibility for a stent. In this example the stent 10 has three interconnecting elements 13 between adjacent radially expandable cylindrical elements 12, which are 120 degrees apart. Each pair of interconnecting elements 13 on one side of a cylindrical element 12 are offset radially 60 degrees from the pair on the other side of the cylindrical element. The alternation of the interconnecting elements 13 results in a stent that is longitudinally flexible in essentially all directions. Various other configurations for the placement of interconnecting elements 13 are possible. However, the interconnecting elements 13 of an individual stent typically should be secured to either the peaks or valleys of the undulating structural elements 12 in order to prevent shortening of the stent during the expansion thereof. Additional details concerning the particular stent depicted in FIG.1 as well as variations thereof are shown, for example, in U.S. Pat. No. 5,514,154.

In one embodiment, the present invention is directed to a method of processing a stent preform using a laser beam. The stent preform may be in the form of a tube, a sheet or any other shape of material into which a stent design is cut. Desirably, the stent preform will be made of metal. Typical metals include stainless steel and an alloy of nickel and titanium, which provides the stent with a thermal memory. The unique characteristic of this alloy, known generally as “Nitinol,” is its thermally triggered shape memory, which allows a stent constructed of the alloy to be cooled and thereby softened for loading into a catheter in a relatively compressed and elongated state, and regain the memorized shape when warmed to a selected temperature, such as human body temperature. Other suitable materials for the stent preform include tantalum, platinum alloys, niobium alloys, cobalt alloys and polymeric materials, as are known in the art. Where the preform is in the form of a sheet, once the desired pattern has been cut into the preform, the preform may be rolled into tubular form. Alternatively, the edges of the tube may be joined together via welding, the use of adhesives or otherwise. The stent diameter is generally very small, so the tubing from which it is made must necessarily also have a small diameter. Typically the stent has an outer diameter on the order of about 0.05-0.13 inches in the unexpanded condition, the same outer diameter of the tubing from which it is made, and can be expanded to an outer diameter of 0.12 inches or more. The wall thickness of the tubing may be about 0.003 to 0.01 inches.

The laser system employed in the present invention generates a pulse train of ordered pulses of radiation with each pulse train being output from the laser system as an output laser beam. The pulse trains output by the laser may be characterized by an amplitude, a pulse width, and an inner train separation time between subsequent pulses in a pulse train (the pulse frequency). The pulse frequency may be constant or varying. That is, the time between subsequent pulses can be adjusted in any desired manner. The laser beam is directed towards the stent preform and impinged onto the stent preform to cut a desired pattern into the stent preform. The laser beam may be moved relative to the stent preform or the stent preform may be moved relative to the laser beam.

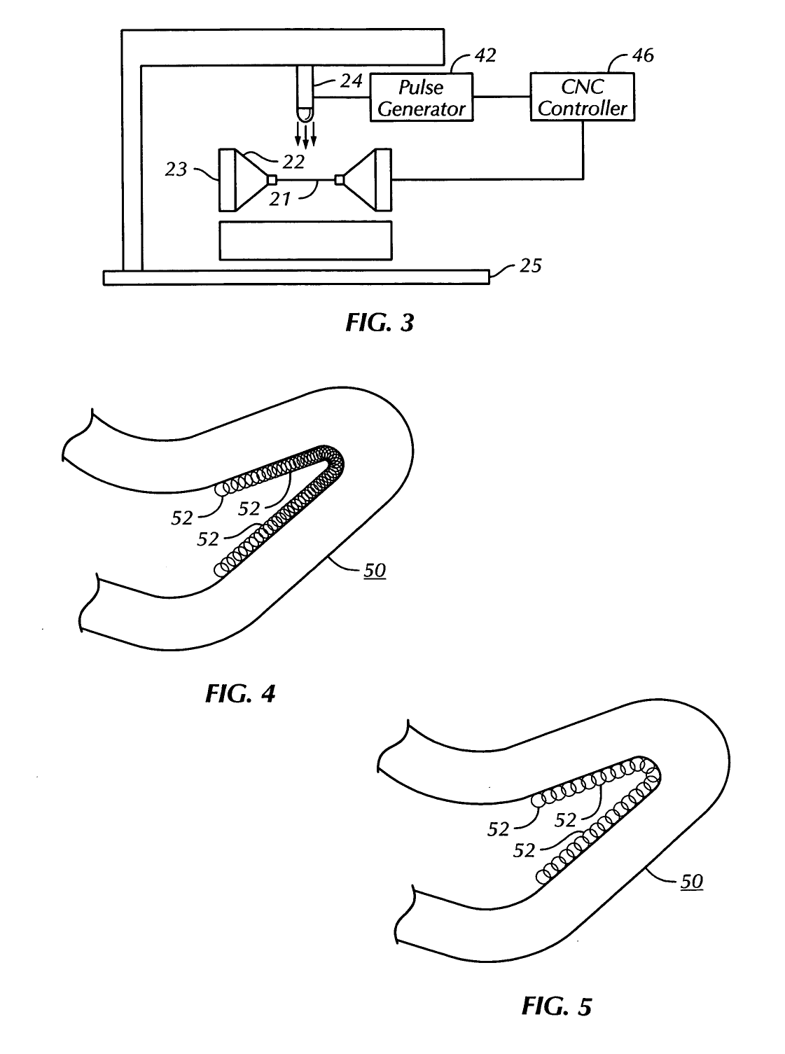

In accordance with the present invention, it is preferred to cut the preform in the desired pattern by means of a machine-controlled laser cutting system as illustrated schematically in FIG. 3. Such machine-controlled laser cutting systems are well known (see, e.g., U.S. Pat. No. 5,780,807) and are commercially available from a number of sources, including for example, LPL Systems and Rofin. As shown, the stent preform 21 is placed in a rotatable collet fixture 22 of a machine-controlled apparatus 23 for positioning the preform relative to the laser 24. The stent may be fabricated about a mandrel (not shown) having a substantially circular external surface and a cross-sectional diameter substantially equal to or less than the internal diameter of the preform 21. According to machine-encoded instructions provided by a controller 46, the preform is rotated and moved longitudinally relative to the laser, which is also machine-controlled. The laser selectively removes the material from the preform by IR melting, evaporation, and/or ablation to cut a pattern into the preform 21. The preform is therefore cut into the discrete pattern of the finished stent.

The process of cutting a pattern into the preform 21 is generally automated except for possibly loading and unloading the length of preform. Referring again to FIG. 3, the cutting may be done, for example, using a CNC-opposing collet fixture 22 for axial rotation of the length of tubing, in conjunction with a CNC X/Y table 25 for movement of the length of tubing axially relative to the machine-controlled laser 24. The X/Y table 25, which has a linear motor that produces very high acceleration and deceleration, moves the preform relative to laser 24 under the control of the controller 46. The program used by controller 46 for control of the apparatus is dependent on the particular configuration used and the pattern to be formed in the preform 21.

Laser source 24 may be, for example, a Nd:YAG or CO₂ laser operating at a wavelength of, e.g., 1,064 nm and 10,600 nm, respectively. Laser source 24 may also be an ultra-fast laser operating on a femtosecond or picosecond timescale. Alternatively, a laser operating at a wavelength of about 193 nm or 248 nm or laser diodes such as those operating at wavelengths between about 800 to 1000 nm may be employed. In one particularly advantageous embodiment of the invention, diode pumped fiber laser may be employed in which the diode provides energy to pump or stimulate a gain element such as a rare-earth element doped in the fiber. Such fiber lasers are advantageous because the laser spatial mode they produce typically does not vary with pulse frequency, a problem that can arise with other types of laser sources. The present invention, however, is not limited to laser sources. More generally, any other appropriate source of electromagnetic energy that is capable of cutting or otherwise processing a preform may be employed in the present invention.

In the present invention, the operational parameters of the laser 24 may be adjusted to yield optimal cutting results, typically characterized by low surface roughness at the edges and a minimal heat-affected zone. The laser parameters that may be adjusted to attain the desirable results include pulse frequency, pulse length, pulse profile, peak pulse power, and average power. To this end the laser 24 includes a function generator 42 to control the pulse frequency and possibly one or more of the other previously mentioned laser parameters. In this way the pulse frequency can be adjusted to produce, for example, relatively short, intense laser pulses that give rise to intense heating to high temperatures of a limited volume of metal, thereby causing melting, evaporation and expulsion of metal from the surface impinged by the beam beyond that which results from the use of a CW laser beam.

In conventional laser cutting processes the pulse frequency of the laser is usually fixed throughout the cutting process. By using a fixed pulse frequency the pulses will impinge on overlapping portions of the preform by varying amounts. The degree of overlap is largely determined by the velocity of the preform at any given time. Since the preform velocity will often be changing as directional changes are required to form the stent pattern, the amount of pulse overlap on the preform will also be changing. For example, FIG. 4 is a plan view of an undulating segment 50 of a stent formed by the application of fixed frequency laser pulses, which are represented by the circles 52. As shown, the degree of pulse overlap increases when the velocity of the preform decreases, such as during angular motion, while the degree of pulse overlap decreases when the velocity of the preform increases, such as during rectilinear motion. In some cases the amount of pulse overlap can be 2-6 times greater along small arc sections of the stent than along linear sections of the stent.

When the laser pulse overlap varies during the cutting process, the mechanical properties of the stent that is formed may be affected in undesirably ways. For example, if excessive heat is applied to a portion of an NiTi stent having a small radius (corresponding to a low velocity and hence a greater degree of pulse overlap), its fatigue properties may be negatively impacted. This problem is exacerbated as stent struts become narrower and thinner, thus providing a smaller conductive path that is available for heat dissipation. In this case it is desirable to use the minimum amount of heat to cut the material. Additionally, the overall uniformity of various stent features and characteristics such as surface finish may be more variable than is desired.

In the present invention the aforementioned problems are overcome by pulsing the laser beam in accordance with a so-called (synchronized pulse output) mode of operation. That is, the pulses are generated so that they impinge on the preform with a fixed incremental distance between them along the preform, regardless of the velocity of the preform. FIG. 5 shows a plan view of the same undulating stent segment depicted in FIG. 4 except that in FIG. 5 the laser beam operates in a synchronized pulse output mode. As shown, the degree of pulse overlap is the same regardless of the velocity of the preform. The differential in the power that is delivered to any given portion of the preform can be quite considerable. For instance, in one illustrative case when operating in the conventional fixed frequency mode at a frequency of 833 Hz, the power density per unit length applied along the arc of the stent segment shown in FIGS. 4 and 5 is about 5.65×10⁴ W/mm². On the other hand, when operating in synchronized pulse output mode, the power density per unit length applied along the arc of the stent is reduced to about 7.06×10³ W/mm², which is about an 800% reduction in power density at the reduced velocity.

Referring again to FIG. 3, the controller 46 in the machine controlled cutting system generates an output signal representative of the velocity of the preform 21. This signal is provided to the pulse generator 42, which in turn varies the appropriate pulse frequency based on the velocity and modulates the laser 24 accordingly. As the velocity of the preform changes, the pulse generator 42 adjusts the pulse frequency of the laser so that the distance between pulses as they impinge on the preform is either constant, or alternatively, varies in some predefined manner that has been previously programmed into controller 46. It should be noted that the various controllers necessary for the operation of the machine controlled cutting system, represented generally by CNC controller 46, which among other functionality provides servo-motion control, may be in embodied in hardware, software, firmware, or any combination thereof.

The present invention is not limited to laser cutting techniques. More generally, the invention encompasses a variety of other processes employed in the manufacture of medical devices in which a pulsed beam of radiation and/or particles is employed. For example, the invention is equally applicable to laser welding, and laser brazing techniques in which a laser or other electromagnetic beam is applied to a joint for the purpose of securing one element of a medical device, such as the strut of a stent, for example, to another element of the medical device such as another strut. The invention is also applicable to laser ablation techniques to provide a surface treatment such as texturing or shock peering or to form a feature on or within any portion of the medical device. Moreover, the present invention is not limited to a pulsed beam of radiation and/or particles, but more generally encompasses the application of any pulsed processing agent to the workpiece so that material is added to or removed from the workpiece, or otherwise modified chemically, mechanically, geometrically, and the like. For instance the processing agent may be a force that is applied to the workpiece surface so as to imprint a pattern in the workpiece. The force may be applied by a piezoelectric actuator, for example.

Additionally, the present invention is not limited to techniques in which one or more operational parameters of the laser (e.g., pulse frequency) are varied in accordance with changes in the relative velocity of the workpiece. For example, the operational parameters may be varied based on the location of the pulsed beam relative to some feature on the workpiece. For instance, in one example the pulse frequency may be varied as the pulsed beam or other processing agent approaches a feature such as a stent junction or other geometric feature of the workpiece. In this case the machine-controlled processing system may include an optical recognition arrangement to determine when a particular feature of the workpiece is to be encountered the pulsed beam or agent.

The present invention also may be used to apply a coating by micro-deposition to a stent in which a train of particles such as droplets are directed onto the stent. The particles are generally a composition that includes a polymer and a drug or other therapeutic agent that is carried by the polymer. The coating may extend continuously over the medical device or it may be selectively applied in a predetermined pattern over all or part of the medical device. The coating many have a uniform or varying composition and/or thickness across its surface. The particles are applied to the medical device through a nozzle of a dispenser assembly. Examples of such dispenser assemblies include ink-jet printheads and other microinjectors capable of injecting small volumes. In the context of the present invention, the dispenser assembly would replace the laser source 24 seen in FIG. 3. The invention advantageously allows the coating to be applied in a more flexible manner to achieve, for instance, a more uniformly thick coating or a coating that varies in thickness over the medical device in a precisely controlled manner. The invention also encompasses the removal of all or part of a coating by applying an appropriate processing agent in a pulsed or periodic manner.

1. A method of manufacturing a medical device from a workpiece, comprising:
generating a pulsed beam of radiation from a radiation source, said pulsed radiation beam being characterized by a prescribed pulse frequency;
directing the pulsed radiation beam onto the workpiece;
moving the workpiece relative to the radiation source so that a prescribed pattern is cut in the workpiece by the pulsed radiation beam; and
adjusting the prescribed pulse frequency based on a change in a parameter pertaining to the relative motion of the workpiece.

2. The method of claim 1 wherein the prescribed pulse frequency is adjusted so that individual pulses are spaced apart from one another when impinging on the workpiece by a fixed distance.

3. The method of claim 1 wherein the parameter pertaining to the relative motion of the workpiece is relative velocity.

4. The method of claim 1 wherein the parameter pertaining to the relative motion of the workpiece is a relative position of a feature associated with workpiece.

5. The method of claim 3 wherein the prescribed pulse frequency decreases as the relative velocity decreases and increases as the prescribed velocity decreases.

6. The method of claim 1 wherein the workpiece is a tubular workpiece.

7. The method of claim 1 wherein the workpiece is planar at least in part.

8. The method of claim 1 wherein said workpiece comprises a material selected from the group consisting of stainless steel, Nitinol, cobalt, chromium, titanium, tantalum, platinum, magnesium, niobium, iron, and alloys thereof.

9. The method of claim 8 wherein the material is a biocompatible material.

10. The method of claim 8 wherein the material is a composite material.

11. The method of claim 1 wherein the medical device is a stent.

12. The method of claim 1 wherein the medical device is a catheter.

13. The method of claim 1 wherein the medical device is a bio-absorbable device.

14. The method of claim 1 wherein the medical device is a guidewire.

15. The method of claim 1 wherein the radiation beam is a laser beam.

16. The method of claim 1 wherein the radiation source generating the pulsed beam is a laser source.

17. The method of claim 16 wherein the laser source is a fiber laser source.

18. A method of processing a medical device formed from a workpiece, comprising:
applying a pulsed processing agent onto the workpiece from a source;
moving the workpiece relative to the source so that the processing agent is applied to the workpiece in a prescribed pattern; and
adjusting a characteristic of the pulsed processing agent based on a change in a parameter pertaining to the relative motion of the workpiece.

19. The method of claim 18 wherein the characteristic of the pulsed processing agent that is adjusted is pulse frequency.

20. The method of claim 18 wherein the pulsed processing agent comprises a pulsed beam of radiation and/or particles.

21. The method of claim 20 wherein the radiation and/or particles is applied to cut the workpiece.

22. The method of claim 20 wherein the radiation and/or particles is applied to weld or braze together first and second components of the workpiece.

23. The method of claim 18 wherein the pulsed processing agent provides a surface treatment to the workpiece.

24. The method of claim 23 wherein the surface treatment comprises application of a surface coating.

25. The method of claim 24 wherein the surface coating comprises a therapeutic agent.

26. The method of claim 24 wherein the surface coating is a metallurgic or polymeric material.

27. The method of claim 24 wherein the surface coating is a biologic material.

28. The method of claim 23 wherein the surface treatment removes a prescribed portion of a surface layer from the workpiece.

29. The method of claim 23 wherein the pulsed processing agent forms an alloy with a surface portion of the workpiece.

30. The method of claim 18 wherein the pulsed processing agent comprises a force that is periodically applied to the workpiece.

31. The method of claim 30 wherein the source of the force is a piezoelectric actuator.

32. The method of claim 18 wherein the pulse frequency is adjusted so that individual pulses are spaced apart from one another when impinging on the workpiece by a fixed distance.

33. The method of claim 18 wherein the parameter pertaining to the relative motion of the workpiece is relative velocity.

34. The method of claim 18 wherein the parameter pertaining to the relative motion of the workpiece is a relative position of a feature associated with workpiece.

35. The method of claim 33 wherein the pulse frequency decreases as the relative velocity decreases and increases as the prescribed velocity decreases.

36. The method of claim 18 wherein the workpiece is a tubular workpiece.

37. The method of claim 18 wherein the workpiece is planar at least in part.

38. The method of claim 18 wherein said workpiece comprises a material selected from the group consisting of stainless steel, Nitinol, cobalt, chromium, titanium, tantalum, platinum, magnesium, niobium, iron, and alloys thereof.

39. The method of claim 38 wherein the material is a biocompatible material.

40. The method of claim 18 wherein the medical device is a stent.

41. The method of claim 18 wherein the medical device is a catheter.

42. The method of claim 18 wherein the medical device is a bio-absorbable device.

43. The method of claim 18 wherein the medical device is a guidewire.

44. The method of claim 18 wherein the processing agent is a laser beam.

45. The method of claim 44 wherein the laser beam is generated by a fiber laser source.

46. The method of claim 38 wherein the material is a composite material.

47. The method of claim 18 wherein a pulse duration of the pulsed processing agent is greater than about 200 psec.

48. The method of claim 18 wherein a pulse duration of the pulsed processing agent is less than about 200 psec.
